(19) United States
(12) Patent Application Publication
(10) Pub. No.: US 2020/0333778 A1
(43) Pub. Date: Oct. 22, 2020

(54) SYSTEM FOR REMOTELY DRIVING A DRIVERLESS VEHICLE

(71) Applicant: Marc LAMBERT, Auriol (FR)

(72) Inventor: Marc LAMBERT, Auriol (FR)

(21) Appl. No.: 16/763,477

(22) PCT Filed: Nov. 30, 2018
(86) PCT No.: PCT/FR2018/053067

§ 371 Date: May 12, 2020

(30) Foreign Application Priority Data
Nov. 30, 2017 (FR) 17/71282

(51) Int. Cl. G05D 1/00; G05D 1/02

(52) U.S. Cl. CPC G05D 1/005; G05D 1/0038; G05D 2201/0212; G05D 1/0238; G05D 1/0255; G05D 1/0022

(57) ABSTRACT

A system for remotely driving a driverless vehicle remotely connected to a remote driving station, includes implementing telepresence terminals, optical and acoustic sensors in the vehicle and in the remote driving station to enable a driver present in the remote driving station to interact in a bidirectional manner with one or several person(s) present around the driverless vehicle thanks to bidirectional optical and acoustic transmissions between the driverless vehicle and the remote driving station. The system for remotely driving a driverless vehicle further provides a transmission tool allowing for a synchronization of the data throughout the transmission chain. This is also useful in the goods and merchandise transportation field.

### TECHNICAL FIELD

The present disclosure relates to a system for remotely driving a driverless vehicle, of the motorized land vehicle type, travelling within an environment, and more particularly a system for remotely driving comprising the driverless vehicle and a remote driving station remotely connected to the driverless vehicle via a communication channel established in a telecommunication network.

Hence, the disclosure concerns the field of remote control, or remote driving, of driverless motorized land vehicles. This system for remotely driving relates to the field of remote operation of a motor-propelled movable object, in other words the remote control of a vehicle and in particular of motorized land vehicles.

### BACKGROUND

Motorized land vehicles (also called MLV as described in Article 2 of the Convention of the European Council of May 4, 1973) primarily ensure the transportation of goods and persons.

There are now proposed fully autonomous vehicles, whose generated benefits are countless and undeniable for a very large number of applications (reduction of the transport cost, optimization of the transport time, reduction of energy needs and reduction of pollution, traffic de-bottlenecking . . . ).

However, there is still a large number of limitations and risks that the autonomous vehicles are not to date able to solve, such as the cost of a fully autonomous vehicle, the judicial accountability in the event of an accident, the behavior of the autonomous vehicle in front of unexpected situations, the reluctance of the users to delegate the control of the vehicle, the protection against hacking, the relationship with police officers, the respect of the privacy of the users of these vehicles . . . .

This demonstrates the importance of the role that the driver occupies in the use of a motorized land vehicle within an environment inside which persons are present, such as an urban environment, but also how his presence on board conditions the uses thereof.

In this respect, it is possible to differentiate two situations. In a first situation, the vehicle is a conventional vehicle driven by a driver, and in this case the persons around the vehicle identify the driver and activate social relationships mechanisms that generate both operational interactions and a relation of trust. In a second situation, the vehicle is an autonomous vehicle driven by an autopilot, and in this case the persons around the vehicle have a very reduced capability for operational interactions (most of them are set out in the traffic code, such as turn lights, headlight flashing, horn, stop light) leading to a very altered and even nonexistent level of trust.

Moreover, it is known, in particular from the document US 2015/346722, to use system for remotely drivings comprising the driverless vehicle and a remote driving station remotely connected to the driverless vehicle, where the driving station receives a driver who will be able to remotely pilot the driverless vehicle.

However, despite the presence of a remote driver, conventional driverless vehicles do not allow for a full interaction with the persons present in the circulation environment of the driverless vehicle, and consequently they are not therefore suited for some applications and in some environments where the interactions with the persons present in the environment of the vehicle are necessary, and even indispensable for a proper completion of the service or for acceptance by both the persons and the municipalities.

In other words, for the persons in the environment (pedestrians, cyclists, drivers, police officers . . . ), the driverless vehicle is still a vehicle without a pilot present in the vehicle, even though a remote driver ensures the driving thereof, and which does not therefore allow interacting with a physically present pilot to reassure, react where needed, exchange a communication, in brief allow for the exchanges that are indispensable to a proper integration of the vehicle in its environment.

Another drawback lies in the indispensable need for a proper communication between the remote driver, located in the remote driving station, and the driverless vehicle, because the driverless vehicle is moving and a loss of communication may lead to a loss of control and therefore to an accident.

### SUMMARY

The present disclosure aims at solving all or part of the aforementioned problem, by providing a solution for an optimum integration within an environment of a driverless motorized land vehicle, remotely piloted by a driver located in a remote driving station.

To this end, it provides a system for remotely driving a driverless vehicle travelling within an environment, said system for remotely driving comprising the driverless vehicle, of the motorized land vehicle type, and a remote driving station remotely connected to the driverless vehicle via a communication channel established in a telecommunication network.

According to the disclosure, the driverless vehicle comprises:
control devices to control a displacement of the driverless vehicle and comprising at least a brake control device, a steering control device and an acceleration control device;
several vehicle sensors coupled to the driverless vehicle, including at least an optical sensor and an acoustic sensor for capturing optical and acoustic analog signals from the environment within which the driverless vehicle travels, at least a movement sensor for capturing movements within the driverless vehicle, and at least a state sensor for capturing a state information relating to the driverless vehicle;
a driver telepresence terminal connected to the control devices to control them according to remote driving signals coming from the remote driving station, said driver telepresence terminal being also connected to the vehicle sensors to receive their captured signals;
a telecommunication device connected to the driver telepresence terminal and intended to establish a remote communication with the remote driving station in order to receive remote driving signals and to emit the captured signals originating from the vehicle sensors.

Moreover, according to the disclosure, the remote driving station comprises:
a seating station to seat a driver;
piloting devices comprising at least a brake piloting device, a steering piloting device and an acceleration piloting device, on which the driver can act to produce remote control signals;
remote driving emitters including at least an optical emitter to replicate the optical analog signals captured by said at least one optical sensor of the driverless vehicle, at least an acoustic emitter to replicate the acoustic analog signals captured by said at least one acoustic sensor of the driverless vehicle, at least a movement emitter to replicate the movements captured by said at least one movement sensor of the driverless vehicle, and at least a state emitter to inform the driver on the state information captured by said at least one state sensor of the driverless vehicle;
a vehicle telepresence terminal connected to the piloting devices to receive the remote driving signals, said vehicle telepresence terminal being also connected to the remote driving emitters to control them according to the captured signals originating from the vehicle sensors;
a communication device connected to the vehicle telepresence terminal and intended to establish a remote connection with the driverless vehicle via the telecommunication network in order to receive the captured signals originating from the vehicle sensors and to emit the remote driving signals.

In the context of the disclosure, a telepresence terminal, whether it includes the driver telepresence terminal or of the vehicle telepresence terminal, is a data processing means which enables a person (the driver) or an object (the vehicle) to have a feeling of being present or having an effect at a location other than their actual location.

In the context of the disclosure, the system for remotely driving further comprises interaction means enabling a driver present in the remote driving station to interact in a bidirectional manner with one or several person(s) present around the driverless vehicle thanks to bidirectional optical and acoustic transmissions between the driverless vehicle and the remote driving station, said interaction means comprising:
station sensors present on the remote driving station including at least an optical sensor and an acoustic sensor for capturing optical and acoustic analog signals coming from the seating station seating the driver, and the vehicle telepresence terminal is connected to the station sensors to receive their captured signals and to communicate them to the driverless vehicle via the telecommunication devices;
vehicle emitters present on the driverless vehicle including at least an optical emitter to replicate the optical analog signals captured by said at least one optical sensor of the remote driving station and at least an acoustic emitter to replicate the acoustic analog signals captured by said at least one acoustic sensor of the remote driving station, and the driver telepresence terminal is connected to the vehicle emitters to control them according to the captured signals of the station sensors;
a transmission tool managing the transmission of the captured signals and the remote driving signals continuously on either side of the communication channel between the driverless vehicle and the remote driving station, wherein the transmission tool manages an uplink stream which originates from the remote driving station to be transmitted to the driverless vehicle, and a downlink stream which originates from the driverless vehicle to be transmitted to the remote driving station, and where the transmission tool comprises for the downlink stream processing means implementing a synchronization of the captured signals originating from the vehicle sensors.

Thus, thanks to the disclosure, the remote driving station is equipped with a vehicle telepresence terminal enabling the driver to interact with the vehicle as well as with the persons present around the vehicle, and on the other hand the driverless vehicle is equipped with a driver telepresence terminal enabling the persons present around the vehicle to interact with the remote driver; these interactions between the driver and the persons thus being bidirectional, and also both visual and auditory.

Hence, the system for remotely driving is designed so as to ensure a driving experience of the remote driver similar in all respects to the same experience as with driving the same vehicle with the driver on board. Moreover, it is obvious that this system for remotely driving enables an optical (and in particular video) transmission in a bidirectional manner (in both directions between the driverless vehicle and the remote driving station) thanks to the optical sensors present both in the driverless vehicle and in the remote driving station.

It should be noted that the above-mentioned interaction means also integrate the other aforementioned members, which comprise the control devices, the vehicle sensors, the telepresence terminals, the communication devices, the piloting devices and the driving emitters, and form together the basis of the system for remotely driving and therefore of the telepresence both on the remote driving station side and on the remote vehicle side.

For this purpose, the system for remotely driving implements a telecommunication between the remote driving station and the driverless vehicle, which involves a synchronization of the data on the downlink stream (and possibly throughout the entire transmission chain) comprising the capture, the transmission and the restitution of vision, hearing and movements, so that the interaction between the remote driver and the driverless vehicle is natural.

This mastering of the synchronization, implemented by the transmission tool, advantageously allows offering a «mirror» effect between the driver present in the vehicle (visual and acoustic replication), which leads to both:
a mastering of the synchronicity of the interactions on either side of the system (mastered real-time); and
an identification of the persons (the driver and the person(s) around the vehicle) on either side of the system (enhanced social experience).

Thus, it should be noted that the disclosure is particularly advantageous in service applications in social environments such as a town, a neighborhood, a village or a professional activity context such as port logistics, goods and merchandise transportation, handling in construction works, cleaning activities in public spaces, because the identification of the driver by the persons present around the vehicle is an essential aspect so as to obtain natural, complex interactions but also with a high added value in the rendered service.

In addition, the system for remotely driving enables the driver to remotely pilot the vehicle while experiencing the same feelings (vision, hearing, movements) and while operating the same actions as if he were on board, and it also enables him to preserve a natural interaction with any person located proximate to the vehicle, such as a pedestrian or a driver of another vehicle. In this interaction type, the communication is mainly visual and auditory, thanks to the station sensors and the vehicle emitters, thereby allowing overcoming the physical absence of the pilot in the vehicle, and therefore preserving a conventional bidirectional communication that does not require any adaptation of the behavior of the driver or of the persons around the driverless vehicle.

In other words, the disclosure enables the remote driver to perceive the environment of the vehicle in the same manner as if he were on board the vehicle, thanks to the visual, hearing and haptic senses (herein the movements) which are essential for the quality of appreciation and apprehension of the manner the vehicle is driven. For example, driving is not the same on a perfectly paved highway as on a highway being grooved (renewal of the surface of the road).

Thus, the accurate replication of the driving feelings for the driver through the visual, hearing and haptic senses will be essential to the full mastering of the means necessary to the remote driving of the vehicle and the disclosure enables him thanks to an accurate replication of these senses which is ensured by a perfectly controlled synchronization of all of the involved senses and controls.

Moreover, the driverless vehicle comprises an autonomous or assisted driving unit connected to the control devices and connected to the driver telepresence terminal for an exclusive control of the control devices by the autonomous or assisted driving unit or by the driver telepresence terminal according to a comparison between at least one driving parameter measured in real-time and at least one associated safety threshold.

Thus, this autonomous or assisted driving unit (also called driving assist or autonomous driving unit) will be able to step in or replace the remote driver to pilot the vehicle, when safety conditions require so, such safety conditions being defined by driving parameters and associated safety thresholds. Thus, the driver telepresence terminal in the driverless vehicle communicates with this autonomous or assisted driving unit; this communication being in charge of managing the exclusive control of only one of said elements (autonomous or assisted driving unit, and driver telepresence terminal) on the control devices of the vehicle.

In a particular embodiment, the driverless vehicle is a vehicle for the delivery of goods and merchandise, said driverless vehicle having an internal compartment for the storage of goods and merchandise.

Thus, the disclosure finds an advantageous application with a vehicle for the delivery of goods and merchandise, in particular in an urban or suburban environment, while bearing in mind at the same time that the disclosure may apply to any type of vehicle belonging to the motorized land vehicles category.

In the field of goods and merchandise delivery, and in particular the so-called «last-kilometer» delivery or logistics, it is nowadays essential to bring in a solution that reconciles in a satisfactory way the main criteria that are cost, roads occupation, pollution and speed of execution, and the disclosure allows addressing at least part of these different criteria.

Indeed, the disclosure ensures a dissociation between the driver and the vehicle, which allows managing a fleet of several delivery vehicles yet without requiring an increase in the number of drivers. Consequently, the rendered service is improved and the human resources necessary for the proper execution of the delivery service are optimized.

In addition, the disclosure allows offering an increased load capacity with the absence of the driver in the vehicle. In other words, it is possible to significantly increase the volume and the payload of goods and merchandise transported especially in the case of use of small vehicles.

Furthermore, as the delivery vehicle is not intended to transport persons, it may be lightened by removing the safety elements and the equipment normally provided for the driver (safety belt, airbags, shock absorbers, seat . . . ). The vehicle thus lightened optimizes the use of its energy, which enables it to significantly length the travel distance and the reduction of its energy footprint.

Finally, the dimensions of the delivery vehicle may be reduced to the strict minimum necessary for the transportation of the goods and merchandise thereby allowing reducing the space occupied on roads accordingly.

Consequently, the present disclosure allows for a better tradeoff between the aforementioned four criteria, namely cost, occupation of roads, pollution and speed of execution.

According to a feature, the internal compartment serves as a support for the at least one optical emitter of the driverless vehicle, which is advantageous for placing the optical emitter(s) at the top portion so as to be visible for the surrounding persons, while ensuring a storage space at the bottom portion.

According to another feature, the driverless vehicle has a windshield and right and left windows and the at least one optical emitter of the driverless vehicle is disposed inside the driverless vehicle so as to be visible from outside via the windshield and right and left windows.

Advantageously, the at least one optical emitter comprises a front display system placed opposite the windshield, a right display system placed opposite the right window and a left display system placed opposite the left window.

According to a variant, the at least one optical emitter comprises a hologram generator.

According to a possibility, the or each display system is a monitor.

According to a possibility of the disclosure, the at least one movement sensor of the driverless vehicle comprises at least an inertial unit measuring the roll, pitch and yaw movements of the driverless vehicle at a driving location, and the at least one movement emitter comprises at least an actuator to replicate the roll, pitch and yaw movements in the seating station of the remote driving station.

It should be noted that the driving location in the driverless vehicle corresponds to the fictional location of the driver in the driverless vehicle, so that he receives information (in particular information on the movement of the vehicle) as perceived in this driving location. If the driverless vehicle is a conventional motorized land vehicle that has undergone modifications to adapt it to the present disclosure, then this driving location will advantageously correspond to the location that is initially intended for the driver, opposite the steering wheel.

According to another possibility of the disclosure, the at least one movement sensor of the driverless vehicle comprises accelerometers measuring the vibrations at the level of the control devices at a driving location, and the at least one movement emitter comprises vibrators to replicate the vibrations in the corresponding piloting devices of the remote driving station.

In an embodiment, the autonomous or assisted driving unit comprises a selection means implementing a selection between:
an autonomous or assisted piloting mode corresponding to piloting exclusively by the autonomous or assisted driving unit; or a remote piloting mode corresponding to piloting by the remote driver;

and moreover, the selection means is designed so as to implement:
a collection of information relating to one or several driving parameter(s);
a comparison of the driving parameter(s) with one or several associated safety threshold(s);
an activation of the autonomous or assisted piloting mode if one of the driving parameters exceeds the corresponding safety threshold.

According to a feature, the driving parameters comprise at least one communication parameter representative of the communication channel established between the telecommunication devices.

Thus, depending on this/these communication parameter(s) representative of the communication channel, the autonomous or assisted driving unit replaces, or not, the remote driver to pilot the vehicle.

According to a particular embodiment, the communication parameter is selected amongst at least one of the following parameters:
a parameter representative of a signal quality;
a parameter representative of a transmission speed;
a parameter representative of a transmission latency;
a parameter representative of a bandwidth of the communication;
a parameter representative of a transmission rate;
a parameter representative of an authentication of the data;
a parameter representative of a synchronization between the driver telepresence terminal and the vehicle telepresence terminal which communicate in the communication channel.

According to another feature, the driving parameters comprise at least one parameter selected amongst the following parameters:
a parameter representative of a trajectory or of a direction of the driverless vehicle;
a parameter representative of a speed or of an acceleration or of a deceleration of the driverless vehicle;
a parameter representative of a presence of an obstacle on the trajectory of the driverless vehicle;
a parameter representative of a responsiveness level of the driver.

According to an embodiment, the selection means is designed so as to implement:
a collection of information relating to one or several communication parameter(s);
a collection of information relating to a parameter representative of a speed of the driverless vehicle;
a collection of information relating to a parameter representative of a presence of an obstacle on the trajectory of the driverless vehicle;
an assessment of a remote driving safety distance based on the parameter representative of a speed of the driverless vehicle and at least one communication parameter;
an assessment of a safety limit distance established on the basis of the parameter representative of a presence of an obstacle on the trajectory of the driverless vehicle, the parameter representative of a speed of the driverless vehicle and a maximum response time between the apparition of an obstacle on the trajectory of the driverless vehicle and the action of the driver on the driverless vehicle in a remote piloting mode;
an activation of the autonomous or assisted piloting mode if the remote driving safety distance exceeds the safety limit distance.

Advantageously, the transmission tool comprises for the uplink stream processing means implementing a synchronization of the remote driving signals originating from the piloting devices and of the captured signals originating from the station sensors.

In an advantageous embodiment, the processing means of the transmission tool for the uplink stream implement a synchronization and a multiplexing of the remote driving signals originating from the piloting devices and of the captured signals originating from the station sensors.

The implementation of the multiplexing, in addition to the synchronization, allows optimizing the transmissions by reducing the delays, and therefore improving the remote driving in terms of responsiveness.

According to a possibility, the processing means of the transmission tool for the uplink stream comprise a first processing block implementing an encoding and a compression of the captured signals originating from the station sensors, followed by a second processing block implementing a synchronization and a multiplexing of the remote driving signals originating from the piloting devices and of the captured signals encoded and compressed in the first processing block.

Advantageously, the processing means of the transmission tool for the downlink stream implementing a synchronization and a multiplexing of the captured signals originating from the vehicle sensors.

According to a possibility, the processing means of the transmission tool for the downlink stream comprise a first processing block implementing an encoding and a compression of the captured signals originating from the vehicle sensors, followed by a second processing block implementing a synchronization and a multiplexing of the captured signals encoded and compressed in the first processing block.

### BRIEF DESCRIPTION OF THE DRAWINGS

Other features and advantages of the present disclosure will appear on reading the detailed description hereinafter, of a non-limiting example of implementation, made with reference to the appended Figures in which:

FIG. 1 is a schematic representation of a system for remotely driving according to the disclosure, with a driverless vehicle and a remote driving station that are remotely connected;

FIG. 2 is a schematic representation of the elements of the driverless vehicle of FIG. 1 serving to the remote driving;

FIG. 3 is a schematic representation of the elements of the remote driving station of FIG. 1 serving to the remote driving;

FIG. 4 is a schematic representation of a driverless vehicle according to the disclosure, illustrating display systems allowing for an interaction between the remote driver and the persons located proximate to the driverless vehicle;

FIG. 5 schematically represents a communications management tool which manages the transmissions of the different data in a system for remotely driving according to the disclosure, between the driverless vehicle and the remote driving station, this FIG. 5 illustrating the different types of data used in the present system for remotely driving as well as the delay imparted by each processing step;

FIG. 6 is a diagram illustrating a method for the synchronization of the telemetric data stream with at least one video data stream, for an implementation in a system for remotely driving according to the disclosure;

FIG. 7 is a schematic representation of a driverless vehicle according to the disclosure, illustrating a safety condition associated to a parameter representative of a presence of an obstacle on the trajectory of the driverless vehicle; and

FIG. 8 is a sequence diagram representing the different sequences of a method for selecting the exclusive piloting amongst the autonomous or assisted driving unit (automated piloting) and the driver telepresence terminal (remote piloting by the remote driver).

### DETAILED DESCRIPTION OF THE DRAWINGS

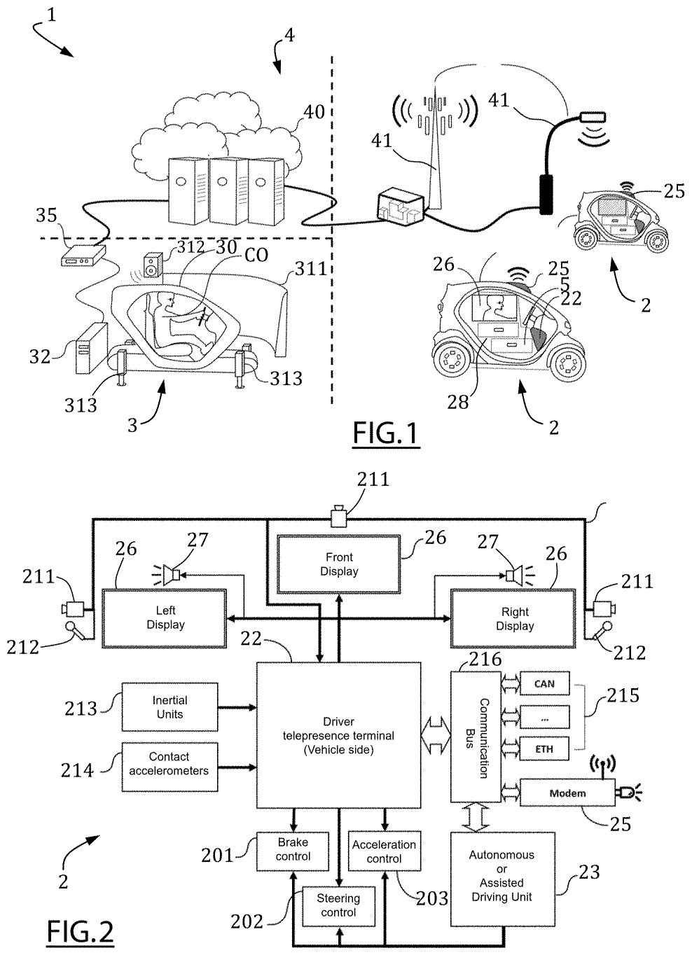

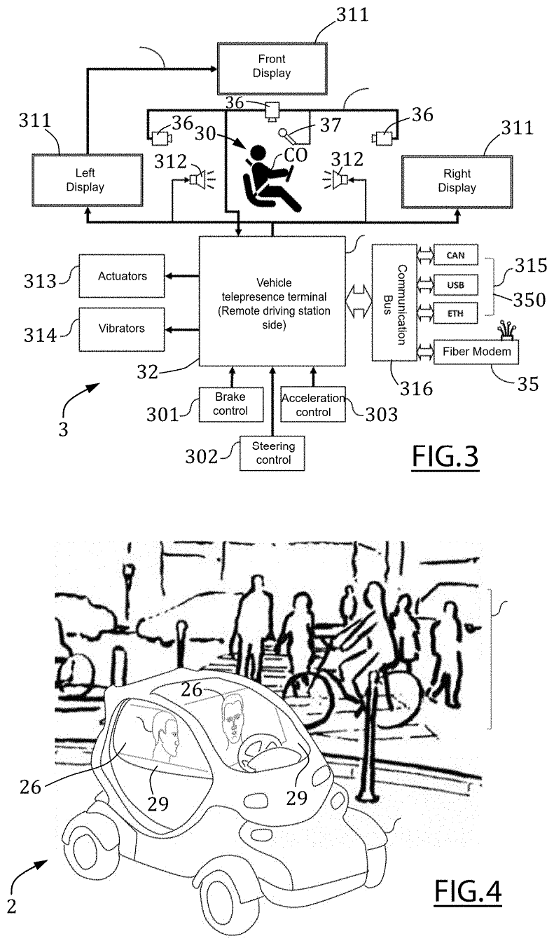

Referring to FIG. 1, a system for remotely driving 1 according to the disclosure comprises at least one driverless vehicle 2 (also called «AUTOPOD») travelling within an environment, and at least one remote driving station 3 (also called «TELEPOD») remotely connected to the driverless vehicle 2 via a communication channel established in a telecommunication network 4. Thus, the driverless vehicle 2 is on a first site, whereas the remote driving station 3 is in a second site distant from the first site.

It is possible to complete the system for remotely driving 1 by the addition of complementary portions allowing enhancing the functions, the modularity or any other types of evolutions of said system for remotely driving 1.

In order to establish the wireless communication channel 40 between the driverless vehicle 2 and the remote driving station 3, the telecommunication network 4 includes a telepresence service platform 40 in charge of the centralized management of all terminals connected to the telecommunication network 4, including the remote driving station(s) 3 and the driverless vehicle(s) 2.

The telepresence service platform 40 is accessible wherever the telecommunication network 4 is deployed. However, because of the fluctuations of bandwidth and latency throughout the entire telecommunication network 4, it is upon the telepresence service platform 40 to determine whether the connection between the terminals 2, 3 is possible.

The telepresence service platform 40 is a computer management means installed on data servers connected to the telecommunication network 4. The geographical location of the data servers has no influence on the implementation of the telepresence service platform 40. This telepresence service platform 40 offers a centralized management allowing mapping all remote driving stations 3 and driverless vehicles 2.

The telecommunication network 4 also includes wireless communication relays 41 distributed over the environment where the driverless vehicle(s) 2 circulate(s); these wireless communication relays 41 may be of the cellular type. These wireless communication relays 41 are part of an existing wireless communication infrastructure.

This wireless communication infrastructure implements a network of stationary wireless communication relays 41 whose density determines the number of simultaneous connections acceptable by the telecommunication network 4.

These wireless communication relays 41 may use the transmission of information by radio waves in the case of LTE, WiMAX or WiFi networks. These wireless communication relays 41 may use the transmission of information by other transmission means such as light waves in the case of a LiFi network.

The link between a wireless communication relay 41 and a driverless vehicle 2 is achieved by the implementation of a telecommunication device 25 integrated to the driverless vehicle 2 and adapted to each type of telecommunication network 4.

To establish the communication between the remote driving station 3 remotely connected to the driverless vehicle 2, these are equipped with respective communication means 25, 35 adapted to ensure the wireless communication via the communication network, in this instance:
the driverless vehicle 2 comprises a telecommunication device 25 intended to establish a wireless communication with the wireless communication relays 41 and therefore to establish a remote communication with the remote driving station 3;
the remote driving station 3 comprises a communication device 35 intended to establish a connection with the telepresence service platform 40 and therefore to establish a remote communication with the driverless vehicle 2 via the telecommunication network 4.

Thus, the communication device 35 forms a connection interface to establish a connection between the remote driving station 3 and the telecommunication network 4. Preferably, this communication device 35 will be of the optical fiber type in order to optimize the bandwidth and the latency, but it is possible to implement other types of links such as wired links, for example an ADSL link or a copper wire link, or wireless links, for example a radio connection of the LTE or WiMAX type, between the remote driving station 3 and the telecommunication network 4. It will then be upon the telepresence service platform 40 to determine whether the transmission quality is good enough to establish the communication between the driverless vehicle 2 and the remote driving station 3.

Hence, the telecommunication device 25 forms a wireless connection interface with the wireless communication relays 41 of the wireless communication infrastructure. This telecommunication device 25 must be compatible with the selected infrastructure type. It may also be compatible with several different types of infrastructures in order to diversify the connection modes and achieve a communication redundancy.

The driverless vehicle 2 comprises a body (or bodywork) receiving the conventional suspension linkage (wheels, suspension . . . ) and propulsion (electric, heat, gas or hybrid) members. This driverless vehicle 2 belongs to the category of Motorized Land Vehicles, and is formed for example by an electric quadricycle which is a vehicle that is well suited to town traffic and which has a large number of attributes to be remotely operated. However, it is possible to implement the present disclosure in any vehicle of the category of Motorized Land Vehicles. Moreover, this driverless vehicle 2 has a windshield and right and left windows 29, as shown in FIG. 4.

As shown in FIG. 1, a second driverless vehicle 2 is represented to illustrate the fact that a driver CO can sequentially drive any driverless vehicle 2 with the same remote driving station 3. Indeed, the driver CO cannot simultaneously drive several driverless vehicles 2, but he has only to park the currently used driverless vehicle 2 to take control of another driverless vehicle 2, these two driverless vehicles 2 may for example be away from one another.

Moreover, this driverless vehicle 2 comprises control devices for controlling a displacement of the driverless vehicle 2, with at least:
a brake control device 201,
a steering control device 202, and
an acceleration control device 203.

These control devices 201, 202, 203 may be mechanical by acting directly on the manual control elements, such as a steering wheel, an accelerator pedal and a brake pedal. These control devices 201, 202, 203 may also be electronic by acting directly or indirectly on actuators intended for this purpose on the driverless vehicle 2.

The driverless vehicle 2 also comprises several vehicle sensors coupled to the driverless vehicle 2, including at least:
an optical sensor 211 for capturing optical analog signals from the environment within which the driverless vehicle 2 travels;
an acoustic sensor 212 for capturing acoustic analog signals from the environment within which the driverless vehicle 2 travels;
a movement sensor 213, 214 for capturing movements within the driverless vehicle 2 at a driving location, and
a state sensor 215 for capturing a state information relating to the driverless vehicle 2.

Thus, the optical sensor 211 forms a means for capturing optical signals. Advantageously, the driverless vehicle 2 comprises three optical sensors 211 made in the form of cameras, with one camera 211 oriented forwards and two other cameras 211 oriented rightwards and leftwards. It is also possible to consider having a forth camera oriented rearwards.

Thus, the acoustic sensor 212 forms a means for capturing acoustic signals. Advantageously, the driverless vehicle 2 comprises two acoustic sensors 212 made in the form of microphones, with one microphone 212 positioned to the right and another microphone 212 positioned to the left of the vehicle.

This/these optical sensors(s) 211 and this/these acoustic sensor(s) 212 are intended for the replication in the remote driving station 3 of the field of view and the soundscape captured in the environment of the driverless vehicle 2. It should be noted that these sensors 211, 212 may implement different number and arrangement of means for capturing the optical and acoustic analog signals within or around the vehicle.

Thus, the movement sensor(s) 213, 214 form(s) means for capturing haptic signals. Advantageously, the movement sensors comprise at least an inertial unit 213 measuring the roll, pitch and yaw movements of the driverless vehicle 2 at the driving location, that is to say one or several inertial unit(s) which are placed so as to measure the roll, the pitch and the yaw at the level of this driving location.

Moreover, the movement sensors may comprise accelerometers 214 measuring the vibrations at the level of the control devices 201, 202, 203 at this driving location, and in particular several contact accelerometers which are disposed at this driving location to measure vibrations for example on the steering column and on the location of the accelerator and brake pedals.

The state sensor(s) 215 is/are in the form of one or several interface(s) on one or several communication bus(es) 216 implemented in the driverless vehicle 2. In other words, the capture of the state information is performed through an acquisition of digital signals from the communication bus(es) 216 of the driverless vehicle 2. The or each communication bus 216 is adapted to the specific constraints of the driverless vehicle 2, commonly called «fieldbus» such as CAN, LIN, FLEXRAY or MOST. However, it is possible to interface with other buses present in the driverless vehicle 2, and in particular «computer» buses such as Ethernet or USB.

Thus, using the communication buses 216 of the driverless vehicle 2, the driverless vehicle 2 recovers and provides state information necessary to the proper use thereof. In particular, the state information concern the fuel or gasoline level for a heat or hybrid propulsion, the charge level of the electric battery for an electric or hybrid propulsion, in general the amount of remaining energy, the displacement speed, the state of the lights and turn lights, the state of the gearbox (Forward, Neutral, Rearward), the emergency stop indications for a technical reason, the information relating to incidents, technical defects or failures, the oil level, the pressure of the tires . . . .

The driverless vehicle 2 further comprises a driver telepresence terminal 22 connected to the control devices 201, 202, 203 to control them according to remote driving signals SCD coming from the remote driving station 3.

This driver telepresence terminal 22 forms a processing unit for the execution of the telepresence client application, in other words for a remote piloting of the vehicle by a driver CO present in the remote driving station 3. In other words, this driver telepresence terminal 22 comprises a telepresence «client» application executed by a processing unit embedded in the driverless vehicle 2.

As shown in FIG. 2, the driver telepresence terminal 22 holds a central place, to the extent that all the other elements (described hereinbefore or hereinafter) are connected thereto directly or via one or several communication bus(s) 216.

Thus, the driver telepresence terminal 22 is connected to the driverless vehicle sensors 211, 212, 213, 214, 215 to receive their captured signals SCV, and to the telecommunication device 25 to receive the remote driving signals SCD and to direct these captured signals SCV.

The driver telepresence terminal 22 of FIG. 1 is represented as disposed inside the driverless vehicle 2, but this representation does not restrict its location. In addition, this representation of the driver telepresence terminal 22 does not mean that there is a necessary dissociation between this driver telepresence terminal 22 and the other processing units present on board the vehicle. Hence, it is possible that a single processing unit is used on board the vehicle to ensure the execution of all the applications required for the operation thereof. The driver telepresence terminal 22 is connected to the different devices present on board the vehicle.

The driverless vehicle 2 comprises an autonomous or assisted driving unit 23 connected to the control devices 201, 202, 203 and connected to the driver telepresence terminal 22, for an exclusive control of the control devices 201, 202, 203:
either by the autonomous or assisted driving unit 23, and the piloting is therefore in an autonomous or assisted piloting mode without any consideration of the commands performed by the driver CO present in the remote driving station 3;
or by the driver telepresence terminal 22, and the piloting is therefore in a remote piloting mode operated by the driver CO present in the remote driving station 3.

This selection of the piloting mode is done according to a comparison of driving parameters measured in real-time and associated safety thresholds (as described later on), in order to determine which amongst the driver telepresence terminal 22 or the autonomous or assisted driving unit 23 obtains exclusive access to the control devices 201, 202, 203.

The autonomous or assisted driving unit 23 is connected to the driver telepresence terminal 22 via a communication bus 216.

The driver telepresence terminal 22 is connected to the communication buses 216 of the driverless vehicle 2, thereby enabling the remote drive CO to remotely control, via specific secondary controls provided in the remote driving station 3, a determined number of secondary devices of the driverless vehicle 2 such as for example the control of the lights, the control of the turn lights, the control of the windshield wipers, the control of the horn . . . .

The control of these secondary technical devices will be done through a generation of digital control signals on the communication bus(es) 216 of the driverless vehicle 2, according to signals coming from the state sensor(s) 350 of the remote driving station 3 by an action of the driver CO on the secondary control(s).

Conversely, the three aforementioned control devices 201, 202, 203 will preferably be taken over in a specific manner in order to reduce to a minimum the risks of error and delay of the commands transmitted by the driver CO, or, where appropriate, by the autonomous or assisted driving unit 23.

The remote driving station 3 comprises a seating station 30 for seating the driver CO, in particular with a seat and a cockpit. Thus, this seating station 30 is a replication of the passenger compartment of the driverless vehicle 2. This seating station 30 may be fixed to a frame attached to the ground via several movable mechanisms or actuators 313 described later on. On board this seating station 30, the driver CO takes place as if he were on board the driverless vehicle 2. The ergonomics in the seating station 30 is similar to what the same driver would feel if he were on board the driverless vehicle 2.

This remote driving station 3 also comprises piloting devices on which the driver CO can act to produce remote control signals SCD and comprising at least:
a brake piloting device 301,
a steering piloting device 302, and
an acceleration piloting device 303.

These piloting devices 301, 302, 303 are in direct contact with the driver CO, and they enable the driver CO to naturally and remotely operate the driverless vehicle 2, to the extent that the driver telepresence terminal 22 will receive the remote control signals SCD originating from these piloting devices 301, 302, 303 to translate them into commands on the control devices 201, 202, 203 and thus pilot the driverless vehicle 2. The steering piloting device 302 may be in the form of a steering wheel, the brake piloting device 301 in the form of a brake pedal and the acceleration piloting device 303 in the form of an accelerator pedal.

The remote driving station 3 comprises remote driving emitters including at least:
an optical emitter 311 to replicate the optical analog signals captured by the optical sensor(s) 211 of the driverless vehicle 2,
an acoustic emitter 312 to replicate the acoustic analog signals captured by the acoustic sensor(s) 212 of the driverless vehicle 2,
a movement emitter 313, 314 to replicate the movements captured by the movement sensor(s) 213, 214 of the driverless vehicle 2, and
at least a state emitter 315 to inform the driver CO on the state information captured by the state sensor(s) 215 of the driverless vehicle 2.

Thus, the optical emitter 311 forms a means for replicating optical analog signals, and it is used for the replication of optical analog signals captured from the driverless vehicle 2. Advantageously, the remote driving station 3 comprises three optical emitters 311 made in the form of display systems (such as for example monitors), with one display system 311 disposed in front of the driver CO, and two other display systems 311 disposed to the right and to the left of the driver CO. This representation is intended to highlight the relationship between the capture of the optical analog signals by means of the previously-described three cameras 211, and a visual replication at a 1:1 scale of the external environment viewed throughout the windshield and he right and left windows of the driverless vehicle 2. However, the remote driving station 3 may implement different number and arrangement of optical emitters 311 for the replication of the optical analog signals, thus the optical emitter 311 may be in the form of a display system enabling the driver CO to have a field of view similar to what he would have on board the driverless vehicle 2.

Thus, the acoustic emitter 312 forms a means for replicating acoustic analog signals and it is used for the replication of acoustic analog signals captured from the driverless vehicle 2, and therefore for replicating the soundscape captured on board the driverless vehicle 2. Advantageously, the remote driving station 3 comprises two acoustic emitters 312 made in the form of speakers or loudspeakers disposed to the right and to the left of the driver CO. This representation is intended to highlight the relationship between the capture of the acoustic analog signals by means of the previously-described two microphones 212. However, the remote driving station 3 may implement different number and arrangement of acoustic emitters 312 for the replication of the acoustic analog signals.

Thus, the movement emitter(s) 313, 314 form means for replicating haptic signals. Advantageously, the movement emitters comprise at least one actuator 313, and possibly several actuators 313, to replicate the roll, pitch and yaw movements in the seating station 30 of the remote driving station 3, in other words to replicate the roll, pitch and yaw movements captured by the inertial unit(s) 213 present in the driverless vehicle 2. The actuator(s) 313 may be mechanical of the hydraulic or electromechanical type and they are fastened on the seating station 30 of the remote driving station 3. Thus, there may be provided several cylinder or servo-drive type linear actuators acting on the seating station 30 to replicate the inclinations of the driverless vehicle 2 as well as the shocks or vibrations transmitted in particular through the wheels.

Moreover, the movement emitters may comprise vibrators 314 to replicate the vibrations in the corresponding piloting devices 301, 302, 303 of the remote driving station 3, in other words to replicate the vibrations captured by the accelerometers 214 on the control devices 201, 202, 203 of the driverless vehicle 2. In particular, these vibrators 314 are placed in the seating station 30 so as to replicate the contact vibrations on the steering wheel and the accelerator and brake pedals forming the piloting devices 301, 302, 303.

The state emitter(s) 315 is/are in the form of one or several interface(s) on one or several communication bus(es) 316 implemented in the remote driving station 3. The remote driving station 3 being intended to be at a fixed location, the commonly used communication buses 316 comprise «computer» buses such as Ethernet or USB. However, it is possible to interface with other types of buses like «fieldbuses» such as CAN, LIN, FLEXRAY or MOST.

The remote driving station 3 comprises a vehicle telepresence terminal 32 connected to the piloting devices 301, 302, 303 to receive the remote driving signals SCD, this driver telepresence terminal 32 being also connected to the communication device 35 in order to receive the captured signals SCV originating from the driverless vehicle sensors 211, 212, 213, 214, 215, and to emit the remote driving signals SCD which will serve to pilot the driverless vehicle 2.

As example, the vehicle telepresence terminal 32 is connected to a set of sensors placed on the piloting devices 301, 302, 303, and the measurements of these sensors are translated into remote driving signals SCD, which are transmitted and then replicated by the corresponding control devices 201, 202, 203 of the driverless vehicle 2.

The vehicle telepresence terminal 32 is also connected to the remote driving emitters 311, 312, 313, 314, 315 to control them according to the captured signals SCV originating from the driverless vehicle sensors 211, 212, 213, 214, 215.

Thus, the vehicle telepresence terminal 32 forms a processing unit in charge of the execution of the telepresence client application on the remote driving station 3 side. Thus, the vehicle telepresence terminal 32 may comprise a telepresence «client» application executed by a processing unit.

This vehicle telepresence terminal 32 is connected to the driver telepresence terminal 22 throughout the different portions of the telecommunication network 4. The data exchanges between these terminals 22, 32 allow establishing and ensuring the telepresence experience between the driver CO and the driverless vehicle 2.

Moreover, the remote driving station 3 comprises remote driving station sensors 36, 37, 350 including at least an optical sensor 36 and an acoustic sensor 37 for capturing optical and acoustic analog signals coming from the seating station 30 seating the driver CO, as well as at least a state sensor 350 for capturing a state information relating to an action of the driver CO on a secondary control provided in the remote driving station 3.

Thus, the optical sensor 36 forms a means for capturing optical signals. Advantageously, the remote driving station 3 comprises three optical sensors 36 made in the form of cameras turned towards the driver CO, with a front camera 36 turned towards the front face of the driver CO and two other cameras 36 oriented towards the right and left profiles of the driver CO.

Thus, the acoustic sensor 37 forms a means for capturing acoustic signals. Advantageously, the remote driving station 3 comprises an acoustic sensors 37 made in the form of a microphone positioned in front of the driver CO to capture his voice.

However, the optical sensor(s) and the acoustic sensor(s) 37 may implement different number and arrangement of means for capturing the optical and acoustic analog signals within the remote driving station 3.

The state sensor(s) 350 is/are in the form of one or several interface(s) on one or several communication bus(es) 316 implemented in the remote driving station 3 linked with one or several secondary control(s) such as for example the control of the lights, the control of the turn lights, the control of the windshield wipers, the control of the horn . . . . In other words, the capture of the state information on these secondary controls is performed through an acquisition of digital signals from the communication bus(es) 316 of the remote driving station 3. The or each communication bus 316 is adapted to the specific constraints of the driverless vehicle 2, commonly called fieldbus» such as CAN, LIN, FLEXRAY or MOST. However, it is possible to interface with other buses present in the remote driving station 3, and in particular «computer» buses such as Ethernet or USB.

The vehicle telepresence terminal 32 is connected to these remote driving station sensors 36, 37, 350 to receive their captured signals SCP and to communicate them to the driver telepresence terminal 22 present in the driverless vehicle 2 via the telecommunication devices 25, 35 and the telecommunication network 4.

In turn, the driverless vehicle 2 comprises driverless vehicle emitters 26, 27 including at least:
an optical emitter 26 to replicate the optical analog signals captured by the optical sensor(s) 36 of the remote driving station 3; and
at least an acoustic emitter 27 to replicate the acoustic analog signals captured by the acoustic sensor(s) 37 of the remote driving station 3.

The driver telepresence terminal 22 is connected to the driverless vehicle emitters 26, 27 to control them according to the captured signals SCP of the remote driving station sensors 36, 37, 350 to establish a relationship between the capture of the optical and acoustic analog signals by the remote driving station sensors 36, 37, 350 in the remote driving station 3, with the replication of the visual and acoustic presence of the driver in the driverless vehicle 2 thanks to the driverless vehicle emitters 26, 27.

Thus, these driverless vehicle emitters 26, 27 form means for replicating the optical and acoustic analog signals captured by the remote driving station sensors 36, 37, 350. These driverless vehicle emitters 26, 27 are used for the replication of the visual and acoustic presence of the driver CO inside the driverless vehicle 2.

Thus, the optical emitter 26 forms a means for replicating optical analog signals, and it is used for the replication of optical analog signals captured from the remote driving station 3 and turned towards the driver CO. Advantageously, the driverless vehicle 2 comprises three optical emitters 26 made in the form of display systems (for example monitors) disposed inside the driverless vehicle 2 so as to be visible from outside via the windshield and the right and left windows 29, with:

a front display system 26 placed opposite the windshield 29 and replicating the optical analog signals captured by the front camera 36 turned towards the front face of the driver CO; and a right display system 26 placed opposite the right window 29 and a left display system placed opposite the left window 29, and replicating the optical analog signals captured respectively by the two other cameras 36 oriented towards the right and left profiles of the driver CO.

This representation is intended to highlight the relationship between the capture of the optical analog signals by means of the previously-described three cameras 36, and a visual replication (for example at a 1:1 scale) by means of the display system 26 of the driver thus visible from outside the driverless vehicle 2 throughout the windows 29, while being in a remote location. However, the driverless vehicle 2 may implement different number and arrangement of optical emitters 26 for the replication of the optical analog signals, thus alternatively the optical emitter 26 may for example be in the form of a holographic display system adapted to generate a holographic (or three-dimensional) image of the driver in the driverless vehicle 2.

Thus, the acoustic emitter 27 forms a means for replicating acoustic analog signals and it is used for the replication of acoustic analog signals captured inside the seating station 30 of the remote driving station 3, and therefore to replicate the voice of the driver CO captured on board the seating station 30. Advantageously, the driverless vehicle 2 comprises two acoustic emitters 27 made in the form of speakers or loudspeakers disposed to the right and to the left of the driverless vehicle 2. These acoustic emitters 27 are located inside or outside the driverless vehicle 2, as long as the acoustic signals can be heard by persons that would be around the driverless vehicle 2 or proximate to the driverless vehicle 2. However, the driverless vehicle 2 may implement different number and arrangement of acoustic emitters 27 for the replication of the acoustic analog signals.

Thus, the system for remotely driving 1 according to the disclosure enables the driver CO to be physically in a given location, namely inside the remote driving station 3, and to act on the driverless vehicle 2 located at another location without feeling any significant discomfort. The same applies to the persons located proximate to the driverless vehicle 2, as they can interact with the driver CO of the driverless vehicle 2, both visually and vocally, although the latter is located at another location and that without feeling any significant discomfort neither.

Referring to FIG. 1, the system for remotely driving 1 finds an advantageous application with a driverless vehicle 2 such as a vehicle for the delivery of goods and merchandise 5, such as for example postal packages, fresh products, sensitive products, letters . . . . For this purpose, the driverless vehicle 2 has an internal compartment 28 for the storage of goods and merchandise 5.

Advantageously, this internal compartment 28 serves as a support for the optical emitter(s) 26 of the driverless vehicle 2, and in particular for the display systems 26 placed in front of the windows 29.

Hence, this system for remotely driving 1 is adapted to optimize the «last-mile» logistics, the driverless vehicle 2 being intended to travel within places occupied by pedestrians as well as drivers of other vehicles such as cars, scooters or bicycles. In this context, the disclosure allows ensuring a natural and bidirectional interaction between the involved parties (the remote driver and the other persons close to the vehicle) in order to facilitate the exchanges and guarantee a continuity of customs generally practiced between the drivers of vehicles or between a vehicle and pedestrians.

In other words, the implementation of the disclosure enables the remote driver CO as well as the persons proximate to the driverless vehicle 2 to:
identify the persons (driver, pedestrian, cyclist . . . );
know where they are paying attention;
predict their intentions;
have social interactions, such as verbal exchanges (common civilities, warnings, questions, answers . . . ) and visual exchange (smile, look . . . ).

Furthermore, with the implementation of the present disclosure, the driver CO is therefore no longer physically on board the driverless vehicle 2. Consequently, a number of equipment normally intended to accommodate the driver CO on board the driverless vehicle 2 are no longer necessary, such as for example the seats, seat belts, airbags, multimedia equipment, ventilation, heating . . . . The removal of this equipment clears a volume and a weight that can then be used for other applications, and in particular for the set-up of the internal compartment 28.

Thus, in the field of «last-mile» logistics, this volume and this weight are put for the benefit of goods and merchandise transportation. The place of the driver thus cleared lives room for the arrangement of an internal compartment 28 for the storage and holding of goods and merchandise. In other words, this internal compartment 28 forms a holding means adapted for the transported goods and merchandise. The internal compartment 28 may be specific depending on the type of goods or merchandise that are to be transported. Thus, this internal compartment 28 may be in the form of a packages cabinet for postal letters and packages, a refrigeration unit for fresh products, a secured trunk for dangerous products . . . .

In the case where the driverless vehicle 2 have additional places beside the place normally intended for the driver, this internal compartment 28 may be extended to occupy the entire useful volume, which increases the capacity of storage of the transported goods and merchandise.

In order to reconcile the storage function and the support function for the optical emitter(s) 26, the optical emitter(s) 26 may be divided into as many portions as there are locations for individualized storage; for example, in the case of a packages cabinet, the optical emitter(s) 26 may be divided into as many display systems as compartments.

The system for remotely driving 1 operates on data management and transmission modes established by the existing telepresence standards such as H323, SIP, XMPP or WebRTC. These have in common the fact of being based on the Internet network communication protocol, called IP, standing for Internet Protocol. Each of these standards processes the telepresence in two distinct portions:
a portion regarding management processed by means of a management tool 9, and
a portion regarding bidirectional transmission of data between the driverless vehicle 2 and the remote driving station 3 processed by a transmission tool 6.

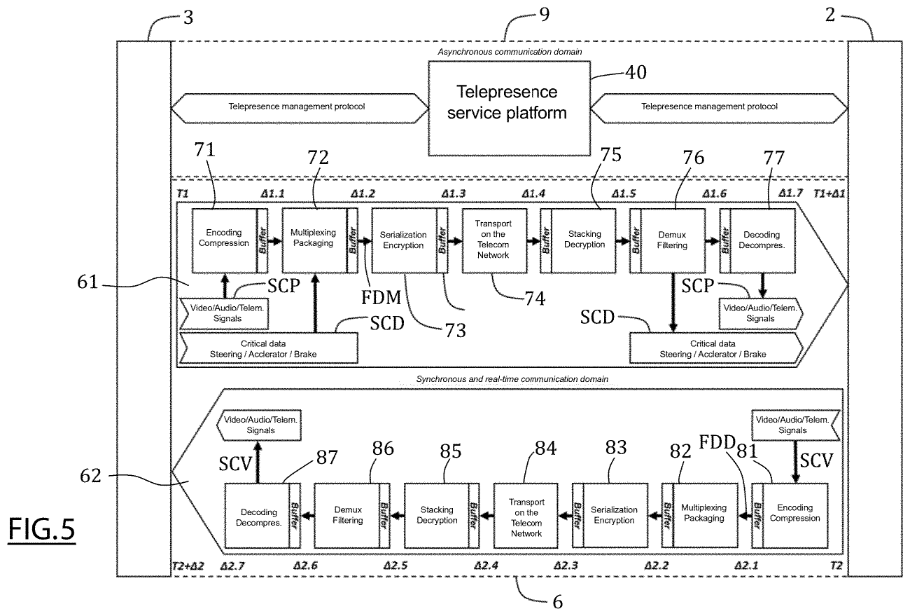

As previously explained, the telepresence service platform 40 is in charge of linking, in a bidirectional manner, a driverless vehicle 2 with a remote driving station 3. For this purpose, the telepresence service platform 40 embeds the management tool 9 schematically illustrated in FIG. 5.

This management tool 9, at the burden of the telepresence service platform 40, maps all the telepresence terminals 22, 32, called «telepresence clients». The management tool 9 of the telepresence service platform 40 is solicited by several telepresence terminals 22, 32 in order to link them through the establishment of a communication channel.

Depending on the standards, this communication channel is indirect, that is to say the exchanged data pass via a data server (also called «PROXY»). Other standards prefer establishing a direct communication channel and use capabilities of configuring the telecommunication network, also called «routing», so as to establish an effective communication between the telepresence terminals 22, 32.

The management tool 9 implements a communication protocol that is often complex which manages all of the constraints of the system. The data exchanges specific to this protocol do not require being carried within a specific time period. Consequently, these management protocols are performed in a so-called «asynchronous» communication domain, that means that it does not take into account neither the synchronicity of the exchanges nor the transmission time periods of the exchanged data.

In other words, this management tool 9 implements data transmissions chains between the driverless vehicle 2 and the remote driving station 3, by means of a centralized management which for example implements a standard management protocol such as those described in the standards H323, SIP, XMPP or WebRTC.

Hence, the management between the telepresence service platform 40, the driverless vehicle 2 and the remote driving station 3 is carried out in an asynchronous mode, with data exchanges that are performed in a random way. This asynchronous communication mode does not take charge of the transmission time periods such that the data exchange times is not determined. Consequently, it is likely that the data exchanges performed by the management tool 9 in the telepresence service platform 40 give rise to variable response times without undermining the proper operation of the telepresence service platform 40.

The transmission tool 6 concerns all data exchanged between the telepresence terminals 22, 32 (or between the driverless vehicle 2 and the remote driving station 3) and concerns in particular the captured signals SCP, SCV and the remote driving signals SCD. The transmission of these data is continuous on either side of the communication channel thus established by the telepresence service platform 40. In this case, the data exchanges should be performed so as to master the transmission times from one end to another of the communication channel. Different techniques may be implemented to reach this result such that: the transmission of the data on synchronous communication buses such that memory buses or USB buses; the transmission on long-range data broadcast networks such as digital television networks DVB-T or DVB-S and the use of the MPEG-TS protocol; and finally, the configuration of the «routing» of a telecommunication network by the implementation of a suitable protocol such as the RTP and SRTP protocols.

The transmission tool 6, as illustrated in FIG. 5, defines a domain of exchange of the telepresence data streams between the remote driving station 3 and the driverless vehicle 2. The communication mode carried out by this transmission tool 6 is synchronous and in real-time, in other words the data exchanges are performed so as to master the transmission times from one point to another of the communication channel. Different techniques are implemented so as to reach this result depending on the context in which the data transmission is performed.

First of all, within one equipment, it is common to carry out a data processing by special-purpose processing units (special-purpose hardware module) or implement a real-time operating system. Moreover, during the transmission on the telecommunication networks, it is common to use transmission protocols dedicated to these communication modes such as RTP/SRTP.

In FIG. 5, inside the transmission tool 6, there are represented two data streams, namely an uplink stream 61 which originates from the remote driving station 3 to be transmitted to the driverless vehicle 2, and a downlink stream 62 which originates from the driverless vehicle 2 to be transmitted to the remote driving station 3. The two streams 61, 62 are substantially identical, except for a few minor details described later on. Each stream 61, 62 transmits in a continuous manner the data acquired at the source, respectively the remote driving station 3 and the driverless vehicle 2, and restitutes them when they reach the destination, respectively the driverless vehicle 2 and the remote driving station 3.

The acquisition time specific to the sensors 211, 212, 213, 214, 215, 36, 37, 350 is not indicated in this diagram because it is negligible in comparison with the other delays caused by the transmission. Similarly, the restitution time specific to the emitters 311, 312, 313, 314, 315, 26, 27 is not indicated in this diagram despite the impact that it may generate on the overall delay of the data transmission.

This representation in FIG. 5 concentrates only on the data streams transmission chain between, on the one hand, the data acquisition interfaces of the sensors and, on the other hand, the restitution of these same data to the interfaces of the emitters at the other end of the communication channel.

For each stream 61, 62, the transmission tool 6 divides the transmission chain into seven steps carried out by seven processing blocks 71 to 77 respectively and 81 to 87 respectively. Some of these processing blocks 71-77 and 81-87 are contiguous to another «buffer» block representing buffer memories, enabling the corresponding processing block to carry out its function.

Each processing block 71-77 and 81-87 as well as each «buffer» block generates a delay in the transmission of the data represented by Δ1.1-Δ1.7 for the uplink stream 61 and Δ2.1-Δ2.7 for the uplink stream 62. These delays cumulate throughout the transmission chains of the streams 61, 62 to reach overall delays at the end of the chain of T1+Δ1 and T2+Δ2 respectively.

The overall delays determine the performance of the system for remotely driving 1, these delays being intended to be as short as possible. This transmission delay problem is settled both by a particular attention paid to the design of the processing block 71-77 and 81-87 and by the implementation of the suitable protocols for the transmission of the data on the telecommunication network 4.

The implementation of these protocols is carried out by the telepresence standards such as H323, SIP, XMPP or WebRTC. However, mastering only the data transmission time is not enough to guarantee a telepresence experience that is sufficient to enable operations such as remote driving of the driverless vehicle 2 by the driver CO.

Indeed, the various steps throughout the transmission chain may undergo fluctuations in their processing time. These fluctuations may generate slight transmission delays of a datum relative to another. This causes a perceptible and very unpleasant feeling for the users. For example, it is not rate, during a visio-conference, to notice a slight delay between the image and the sound. In the case of the remote driving implemented by the disclosure, an annoyance of this type between the field of view and the inclination of the seating station 30 of the remote driving station 3 may cause the total loss of control of the driverless vehicle 2.

In order to resolve this risk of desynchronization between the different data sources, all of the data of the driverless vehicle 2 for the uplink stream 61 and all of the data of the remote driving station 3 for the downlink stream 62, are synchronized and then multiplexed within a single stream of uplink data FDM for the uplink stream 61 and a single stream of downlink data FDD for the downlink data 62.

Thus, the transmission tool 6 comprises, for the uplink stream 61, a first processing block 71 implementing an encoding and a compression of the captured signals SCP originating from the remote driving station sensors 36, 37, 350, followed by a second processing block 72 implementing a synchronization and a multiplexing of the remote driving signals SCD originating from the piloting devices 301, 302, 303 and the captured signals SCP encoded and compressed in the first processing block 71.

Similarly, the transmission tool 6 comprises, for the downlink stream 62, a first processing block 81 implementing an encoding and a compression of the captured signals SCV originating from the driverless vehicle sensors 211, 212, 213, 214, 215, followed by a second processing block 82 implementing a multiplexing of the captured signals SCV encoded and compressed in the first processing block 82.

In this manner, the transmission fluctuations of the entire system may cause a slight variation of the overall delay time T1+Δ1 or T2+Δ2, but has no incidence on the synchronization of all of the output data used to achieve the telepresence experience required by the remote driving.

Moreover, and as previously described for the uplink stream 61, in order to reduce as much as possible the transmission time of the remote driving signals SCD, the multiplexing of the captured signals SCP and the remote driving signals SCD is carried out in the second processing block 72 because these remote driving signals SCD do not need to be compressed.

Afterwards, the transmission tool 6 successively comprises, for the uplink stream 61 (respectively the downlink stream 62):
a third processing block 73 (respectively 83) for a serialization and an encryption of the data multiplexed in the second processing block 72 (respectively 82), then
a fourth processing block 74 (respectively 84) for a transmission of the data serialized and encrypted in the telecommunication network 4; then
a fifth processing block 75 (respectively 85) for a stacking and a decryption of the data coming from the telecommunication network 4;
a sixth processing block 76 (respectively 86) for a demultiplexing and a filtering of the data coming from the fifth processing block 75 (respectively 85);
a seventh processing block 77 (respectively 87) for a decoding and a decompression of the data coming from the sixth processing block 76 (respectively 86).

On completion of the uplink stream 61, at the level of the driverless vehicle 2, the remote driving signals SCD are recovered at the output of the sixth processing block 76, whereas the captured signals SCP are recovered at the output of the seventh processing block 77. Indeed, the restitution of the remote driving signals SCD is carried out after the sixth step, before the last step of the transmission chain, since these remote driving signals SCD have not been decompressed or decoded.

At the end of the downlink stream 62, the captured signals SCV are recovered at the output of the processing block 87.

Consequently, the specific processing of the remote driving signals SCD enables a reduction of the overall period of the system by Δ1.1 and Δ1.7 in the uplink stream 61. This particularity does not appear in the downlink stream 62 because, in this case, these remote driving signals SCD (which comprises control signals) do not exist.

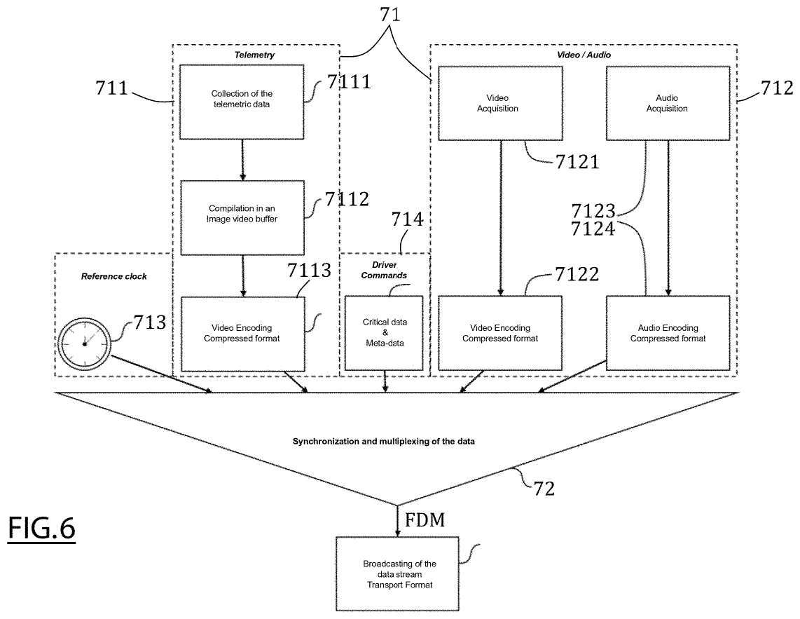

FIG. 6 is a diagram which illustrates the means implemented in the processing block 71 and in the second processing block 72, in order to ensure a synchronization and a multiplexing of the remote driving signals SCD and of the captured signals SCP which are transmitted on the communication channel in the uplink stream 61.

The captured signals SCP comprise:
state sensor(s) 350, that is to say all of the data other than video and audio such that the state information (data acquired on the communication bus(es) 316);
optical data (or video streams) which originate from the optical sensor(s) 36; and
audio data (or audio streams) which originate from the acoustic sensor(s) 37.

The telepresence standards such as H323, SIP, XMPP or WebRTC have mechanisms for transmitting the video and audio streams from several sources towards several destinations. These standard mechanisms ensure the steps of acquiring, encoding, multiplexing and serializing the video and audio streams before being transmitted on the telecommunication network. Similarly, these telepresence standards ensure the reverse steps of deserializing, filtering, decoding and restituting these same data after reception from the telecommunication network.

Each standard defines a multiplexing format of the data in connection with the management of the transmission of the telepresence data. These formats are also called «transport format» the main ones being MPEG-TS of the standard ISO/IEC 13818-1 and RTP. In addition, it is possible to add to these mechanisms a method for encrypting the data stream before transmission on the network. The reverse method is then applied on reception of the data and thus allows ensuring the confidentiality of the data. In this case, the transport format RTP is translated in SRTP intended to this end, related to the standards RFC 3550 and RCF 3711.

Referring to FIG. 6, the first processing block 71 is split into a first sub-block 711 dedicated to the telemetric data, and a second sub-block 712 dedicated to the optical data and to the audio data (video and audio streams). There is also provided a reference clock 713 necessary to the synchronization and multiplexing operations.

In the first sub-block 711, there are successively provided:
a telemetric data collection means 7111 which collects the telemetric data originating, for recall, from the state sensor(s) 350;
a telemetric data compilation means 7112, which implements a formatting (or a compilation) of all of the telemetric data in a data table compatible with the format of an image buffer at the input of the encoding means 7113, for example with a conversion of each triplet or quadruplet of bytes of the telemetric data table into a chromatic information according to a correspondence table;
an encoding means 7113 (in other words a video encoder) which implements an encoding of the telemetric data formatted into an existing compressed video standard format, such as H264, H265, VP8 or VP9.

In the second sub-block 712, there are provided:
a video line successively comprising an optical data acquisition means 7121 which receives the optical data originating, for recall, from the optical sensor(s) 36, and an encoding means 7122 (in other words a video encoder similar to the encoding means 7113) which implements an encoding of the optical data in an existing compressed video standard format, such as H264, H265, VP8 or VP9;
an audio line successively comprising an audio data acquisition means 7123 which receives the audio data originating, for recall, from the acoustic sensor(s) 37, and an encoding means 7124 (in other words an audio encoder) which implements an encoding of the audio data in a compressed standard format compatible with the existing compressed video format.

Hence, the second processing block 72 receives at the input:
the clock signal coming from the reference clock 713;
the encoded telemetric data in a compressed video standard format, originating from the encoding means 7113;
the encoded video data in the same compressed video standard format, originating from the encoding means 7122;
the encoded audio data in a format compatible with the compressed video standard format, originating from the encoding means 7124; and
the remote driving signals SCD originating from the piloting devices 301, 302, 303, and in particular originating from a collection means 714 which collects the data originating from the different piloting devices 301, 302, 303.

The second processing block 72 operates a synchronization and a multiplexing of the encoded telemetric data, the encoded audio data, the encoded video data and the remote driving signals, while considering the clock signal as a reference.

Thus, the telemetric data, the video data, the audio data and the remote driving signals are multiplexed into a single transport signal (for recall, called uplink data stream FDM) in an existing format to be broadcasted on the telecommunication network 4, and the data are restituted following the decoding of the uplink data stream FDM by an existing video decoder.

In the downlink stream 62, the first processing block 81 and the second processing block 82 implement the same means on the captured signals SCV originating from the driverless vehicle sensors 211, 212, 213, 214, 215.

The captured signals SCV comprise:
telemetric data which originate from the movement sensors 213, 214 and state sensors 215, that is to say all the data other than video and audio such as the haptic data and the state information (data acquired on the communication bus(es) 216);
optical data (or video stream) which originate from the optical sensor(s) 211; and
audio data (or audio stream) which originate from the acoustic sensor(s) 212.

The first processing block 81 is split into a first sub-block dedicated to the telemetric data, and a second sub-block dedicated to the optical data and to the audio data (video and audio streams). There is also provided a reference clock necessary to the synchronization and multiplexing operations.

In the first sub-block, there are successively provided:
a telemetric data collection means which collects the telemetric data originating, for recall, from the movement sensors 213, 214 and from the state sensor(s) 215;
a telemetric data compilation means, which implements a formatting (or a compilation) of all of the telemetric data in a data table compatible with the format of an image buffer at the input of the encoding means, for example with a conversion of each triplet or quadruplet of bytes of the telemetric data table into a chromatic information according to a correspondence table;
an encoding means (in other words a video encoder) which implements an encoding of the telemetric data formatted into an existing compressed video standard format, such as H264, H265, VP8 or VP9.

In the second sub-block, there are provided:
a video line successively comprising an optical data acquisition means which receives the optical data originating, for recall, from the optical sensor(s) 211, and a video encoding means (in other words a video encoder similar to the aforementioned encoding means) which implements an encoding of the optical data in an existing compressed video standard format, such as H264, H265, VP8 or VP9;
an audio line successively comprising an audio data acquisition means which receives the audio data originating, for recall, from the acoustic sensor(s) 212, and an audio encoding means (in other words an audio encoder) which implements an encoding of the audio data in a compressed standard format compatible with the existing compressed video format.

Hence, the second processing block 82 receives at the input:
the clock signal coming from the reference clock;
the encoded telemetric data in a compressed video standard format, originating from the encoding means of the first sub-block;
the encoded video data in the same compressed video standard format, originating from the video encoding means of the second sub-block;
the encoded audio data in a format compatible with the compressed video standard format, originating from the audio encoding means of the second sub-block.

The second processing block 82 operates a synchronization and a multiplexing of the encoded telemetric data, the encoded audio data and the encoded video data, while considering the clock signal as a reference.

The following description concerns the driving parameters used to select the autonomous or assisted piloting mode (piloting by the autonomous or assisted driving unit 23) or the remote piloting mode (piloting by the remote driver CO), as well as the method for selecting either one of these two modes.

These driving parameters comprise at least a communication parameter representative of the communication channel established between the telecommunication devices 25, 26, in other words between the remote driving station 3 and the driverless vehicle 2.

As example, the communication parameter is selected amongst at least one of the following parameters (and may therefore comprise several ones of these parameters):
a parameter representative of a signal quality;
a parameter representative of a transmission speed;
a parameter representative of a transmission latency;
a parameter representative of a bandwidth of the communication;
a parameter representative of a transmission rate;
a parameter representative of an authentication of the data;
a parameter representative of a synchronization between the driver telepresence terminal and the vehicle telepresence terminal which communicate in the communication channel.

For example, the parameter representative of a signal quality may correspond to an error rate of the received data.

For example, the parameter representative of a transmission speed may correspond to a data transmission time on the communication channel.

For example, the parameter representative of a transmission latency may correspond to an overall time period or an overall delay on either side of the telecommunication network.

For example, the parameter representative of a bandwidth of the communication may correspond to a maximum amount of data acceptable by the communication channel without any increase of the transmission time period.

For example, the parameter representative of an authentication of the data may correspond to an identification and a certification of the sources of the data.

For example, the parameter representative of a synchronization may correspond to a synchronization between the different types of data so that the user experience on either side of the system is realistic.

Indeed, the proper operation of the present system for remotely driving 1 is, as previously described, very dependent of the data transmission throughout the communication channel, the latter having been established by the telepresence service platform 40 between the remote driving station 3 and the driverless vehicle 2. Consequently, the telepresence experience may be disturbed and even interrupted during a driving period because of defects or delays in the communication.

When these problems occur, it is essential to exclusively implement the autonomous or assisted piloting mode for example in order to stop the displacement of the driverless vehicle 2, remedy to the temporary absence of control of the driver CO by ensuring the continuous driving of the driverless vehicle 2 until the communication is established again, or else, take full control of the driving of the driverless vehicle 2 until reaching the intended destination point in an autonomous manner.

Also, it should be considered that even if the communication is not disturbed, the transmission throughout the communication channel from the driverless vehicle 2 towards the remote driving station 3 and then the reverse transmission from the remote driving station 3 towards the driverless vehicle 2 causes a non-negligible time period when the driver CO must react to an unexpected and urgent situation. This time period adds to the normal response time of the driver CO in the case where the latter was on board the vehicle.

Thus, it is advantageous to also consider other parameters, namely driving parameters which comprise at least one parameter selected from the following parameters (and may therefore comprise several ones of these parameters):
a parameter representative of a trajectory or of a direction of the driverless vehicle 2;
a parameter representative of a speed or of an acceleration or of a deceleration of the driverless vehicle 2;
a parameter representative of a presence of an obstacle on the trajectory of the driverless vehicle 2;
a parameter representative of a responsiveness level of the driver CO.

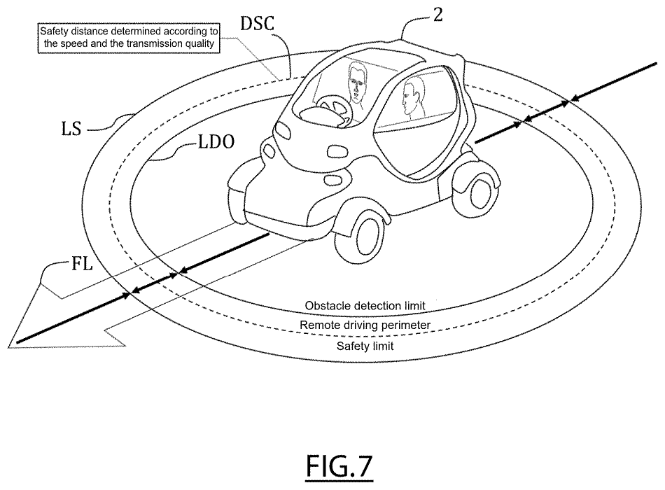

For recall, these parameters are compared to thresholds, and it is thus possible for example to establish safety distances (cf. FIG. 7) that are defined in particular by the legislator according to the speed and the location where the driverless vehicle 2 is travelling. These safety distances are established in order to enable any driver to have enough time to perceive the danger, determine the response and act in order to avoid the collision.

This safety distance is common to any driver in spite of a response time that varies depending on various criteria such as the age, the attention or the health condition.

Consequently, since the present system for remotely driving 1 adds an additional time period, it is possible to implement, thanks to these parameters and thanks to the autonomous or assisted driving unit 23, a mode that automatically (without any intervention of the driver CO) allows for example:
compensating for a lack of response of the driver upon the occurrence of an obstacle on the trajectory of the driverless vehicle 2;
managing the disturbances on the communication channel between the remote driving station 3 and the driverless vehicle 2 as previously described;
limiting the speed of displacement of the driverless vehicle 2 at a maximum speed determined based on data transmission quality criteria comprising the overall time period on the communication channel.

FIG. 7 illustrates a driverless vehicle 2 during displacement, with an illustration of different limits around the driverless vehicle 2. This trajectory of the driverless vehicle 2 is schematized by an arrow FL oriented forwards, bearing in mind that the following description applies to any trajectory of the driverless vehicle 2.

In the remote piloting mode, the driverless vehicle 2 is fully controlled by the driver CO from the remote driving station 3. In this remote driving mode, the driver telepresence terminal 22 is installed, for recall, in the driverless vehicle 2, communicates with the autonomous or assisted driving unit 23 in order to obtain an exclusive access to the control devices 201, 202, 203 present in the driverless vehicle 2.

During this remote piloting mode, the autonomous or assisted driving unit 23 checks up in particular, using means that are specific thereto, that no obstacle lies on the trajectory FL of the vehicle, which translates in a monitoring of a parameter representative of a presence of an obstacle on the trajectory of the driverless vehicle 2. This monitoring of this parameter representative of a presence of an obstacle on the trajectory of the driverless vehicle 2 is ensured for example by a set of radar-type sensors or another detector whose detection range is limited to an obstacle detection limit LDO, which is in the form of a circle.

In the case of a detection of an obstacle, and under conditions specific to the autonomous or assisted driving unit 23, this autonomous or assisted driving unit 23 automatically takes over the piloting so as to switch into an autonomous or assisted piloting mode (exclusive piloting by the autonomous or assisted driving unit 23), in other words the autonomous or assisted driving unit 23 takes control of the control devices 201, 202, 203 in order to perform an emergency stoppage and/or an emergency obstacle avoidance.

During this remote piloting mode, a safety limit distance LS, predefined for the driverless vehicle 2, is also taken into consideration when in the remote piloting mode. This safety limit distance LS is determined according to the following criteria:
a parameter representative of a presence of an obstacle on the trajectory of the driverless vehicle 2 (in other words a detection of an obstacle);
a maximum response time between the apparition of an obstacle on the trajectory of the driverless vehicle 2 and the action of the driver CO on the driverless vehicle 2 in a remote piloting mode (thus integrating the uplink and downlink transmission times and the reaction time period of the driver) which translates the fact that the driver CO has enough time to notice the obstacle and remotely act on the driverless vehicle 2 in order to avoid the collision;
the speed of the driverless vehicle 2 which is taken into consideration to enable the autonomous or assisted driving unit 23 to intervene in an effective manner when the obstacle (or the danger) could be detected.

During this remote piloting mode, a remote driving safety distance DSC is also taken into consideration during the remote piloting mode. This remote driving safety distance DSC is assessed according to the speed of the driverless vehicle 2 and one or several communication parameter(s) representative of a signal quality between the driverless vehicle 2 and the remote driving station 3.

If the speed increases, the remote driving safety distance DSC increases accordingly. When the speed of the driverless vehicle 2 is such that the remote driving safety distance DSC exceeds the safety limit distance LS, then the autonomous or assisted driving unit 23 intervenes in the piloting so that an acceleration command (a command of the driver CO on the acceleration control device 203) is no longer taken into account until the speed of the driverless vehicle 2 falls down to the point where the remote driving safety distance DSC falls below the safety limit distance LS.

In particular, the parameter representative of a signal quality is assessed according to the rate, latency, synchronization and authentication information of the data streams of the communication channel. If the transmission quality is degraded, the remote driving safety distance DSC increases accordingly. When the transmission quality is such that the remote driving safety distance DSC exceeds the safety limit distance LS, then the autonomous or assisted driving unit 23 takes on the exclusive control of the control devices 201, 202, 203 of the driverless vehicle 2 (automatic switch into the autonomous or assisted piloting mode) in order to take control of the driverless vehicle 2 in an appropriate manner, for example to stop the driverless vehicle 2, continue driving in a transient manner or drive autonomously to destination (possibly the time that the transmission quality recovers a level such that the remote driving safety distance DSC falls below the safety limit distance LS).

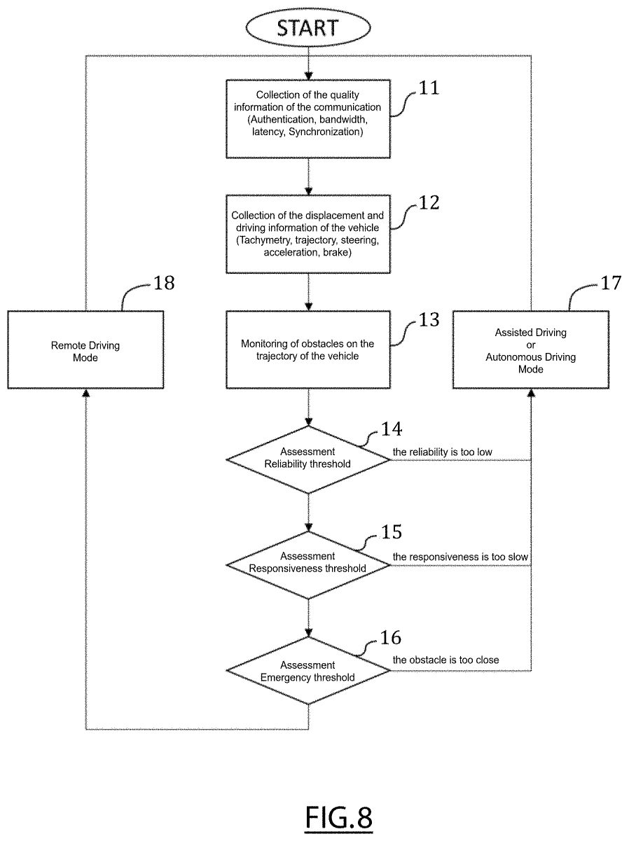

FIG. 8 illustrates the method for selecting between the autonomous or assisted piloting mode and the remote piloting mode. For this purpose, the system for remotely driving 1 comprises a selection means which implements this selection method.

At start («START»), the driverless vehicle 2 is in the remote piloting mode.

This selection method implements a first collection step 11 for collecting information relating to one or several communication parameter(s). In the following description, this first collection step 11 operates a collection of parameters relating to a quality of the data transmission on the communication channel, in particular with information on:
the data rate, also called bandwidth (a parameter representative of a bandwidth of the communication or a parameter representative of a transmission rate);
the transmission latency, also called delay (a parameter representative of a transmission latency);
the synchronization of the data (a parameter representative of a synchronization);
the authentication of the source of the data (a parameter representative of an authentication of the data).

This selection method implements a second collection step 12 for collecting information relating to the displacement and to the trajectory of the vehicle. In the following description, this second collection step 12 operates a collection of the following parameters:
a parameter representative of a speed of the driverless vehicle 2, also called tachometric parameter;
a parameter representative of a trajectory or of a direction of the driverless vehicle 2, in particular by collecting a position of the steering wheel of the driverless vehicle 2;
a parameter representative of a deceleration (or of a braking) of the driverless vehicle 2 or of a level of braking operated by the driver CO in the remote driving station 3;
a parameter representative of an acceleration of the driverless vehicle 2 or of a level of acceleration operated by the driver CO in the remote driving station 3.

This selection method implements a third monitoring step 13 for monitoring obstacles on the trajectory of the driverless vehicle 2, which amounts to a collection of a parameter representative of a presence of an obstacle on the trajectory of the driverless vehicle 2. As explained before, this monitoring may be operated by the autonomous or assisted driving unit 23 using its own means such as a set of radar-type sensors or another detector.

This selection method implements a fourth transmission reliability assessment step 14 which implements an assessment of a reliability of the transmission between the driverless vehicle 2 and the remote driving station 3, as previously described with reference to FIG. 7 with the calculation of the remote driving safety distance DSC, and:
if the reliability is too low, then the selection method switches into a step of selecting the autonomous or assisted piloting mode 17;
else, the selection method proceeds with the fifth responsiveness threshold assessment step 15.

Thus, this selection method implements a fifth responsiveness reliability assessment step 15 which implements an assessment of a reliability of the responsiveness of the driver to an unexpected event, as previously described with reference to FIG. 7 with the safety limit distance LS, and:
if the responsiveness of the driver is too slow, then the selection method switches into the step of selecting the autonomous or assisted piloting mode 17;
else, the selection method proceeds with the sixth emergency threshold assessment step 16.

Thus, this selection method implements a sixth emergency threshold assessment step 16 which implements an assessment of the emergency threshold following a detection of an obstacle by the autonomous or assisted driving unit 23, as previously described with reference to FIG. 7 with the obstacle detection limit LDO, and:
if the obstacle is too close, then the selection method switches into the step of selecting the autonomous or assisted piloting mode 17;
else, the selection method proceeds with the step of selecting (or holding) the remote piloting mode 18, and the selection method restarts.

1. A system for remotely driving a driverless vehicle, said system for remotely driving comprising the driverless vehicle and a remote driving station remotely connected to the driverless vehicle via a communication channel established in a telecommunication network,
said driverless vehicle comprising:
a plurality of control devices to control a displacement of the driverless vehicle and comprising at least a brake control device, a steering control device, and an acceleration control device;
a plurality of vehicle sensors coupled to the driverless vehicle, including at least an optical sensor and an acoustic sensor for capturing optical and acoustic analog signals from the environment within which the driverless vehicle travels, at least a movement sensor for capturing movements within the driverless vehicle, and at least a state sensor for capturing a state information relating to the driverless vehicle;
a driver telepresence terminal connected to the control devices to control them according to remote driving signals coming from the remote driving station, said driver telepresence terminal being also connected to the vehicle sensors to receive their captured signals;
a telecommunication device connected to the driver telepresence terminal and intended to establish a remote communication with the remote driving station via the telecommunication network in order to receive remote driving signals and to emit the captured signals originating from the vehicle sensors;
an autonomous or assisted driving unit connected to the control devices and connected to the driver telepresence terminal for an exclusive control of the control devices by the autonomous or assisted driving unit or by the driver telepresence terminal according to a comparison between at least one driving parameter measured in real-time and at least one associated safety threshold;
said remote driving station comprising:
a seating station to seat a driver;
piloting devices comprising at least a brake piloting device, a steering piloting device and an acceleration piloting device, on which the driver can act to produce remote control signals;
a plurality of remote driving emitters including at least an optical emitter to replicate the optical analog signals captured by said at least one optical sensor of the driverless vehicle, at least an acoustic emitter to replicate the acoustic analog signals captured by said at least one acoustic sensor of the driverless vehicle, at least a movement emitter to replicate the movements captured by said at least one movement sensor of the driverless vehicle, and at least a state emitter to inform the driver on the state information captured by said at least one state sensor of the driverless vehicle;
a vehicle telepresence terminal connected to the piloting devices to receive the remote driving signals, said vehicle telepresence terminal being also connected to the remote driving emitters to control them according to the captured signals originating from the vehicle sensors;
a communication device connected to the vehicle telepresence terminal and intended to establish a remote connection with the driverless vehicle via the telecommunication network in order to receive the captured signals originating from the vehicle sensors and to emit the remote driving signals;
said system for remotely driving further comprising interaction means enabling a driver present in the remote driving station to interact in a bidirectional manner with one or several person(s) present around the driverless vehicle thanks to bidirectional optical and acoustic transmissions between the driverless vehicle and the remote driving station, said interaction means comprising:
a plurality of station sensors present on the remote driving station including at least an optical sensor and an acoustic sensor for capturing optical and acoustic analog signals coming from the seating station seating the driver, and the vehicle telepresence terminal is connected to the station sensors to receive their captured signals and to communicate them to the driverless vehicle via the telecommunication devices;
a plurality of vehicle emitters present on the driverless vehicle including at least an optical emitter to replicate the optical analog signals captured by said at least one optical sensor of the remote driving station and at least an acoustic emitter to replicate the acoustic analog signals captured by said at least one acoustic sensor of the remote driving station, and the driver telepresence terminal is connected to the vehicle emitters to control them according to the captured signals of the station sensors;
a transmission tool managing the transmission of the captured signals and the remote driving signals continuously on either side of the communication channel between the driverless vehicle and the remote driving station, wherein the transmission tool manages an uplink stream which originates from the remote driving station to be transmitted to the driverless vehicle, and a downlink stream which originates from the driverless vehicle to be transmitted to the remote driving station, and wherein the transmission tool comprises for the downlink stream processing means implementing a synchronization of the captured signals originating from the vehicle sensors.

2. The system for remotely driving according to claim 1, wherein the driverless vehicle is a vehicle configured to for the delivery goods and merchandise, said driverless vehicle having an internal compartment for the storage of goods and merchandise.

3. The system for remotely driving according to claim 2, wherein the internal compartment serves as a support for the at least one optical emitter of the driverless vehicle.

4. The system for remotely driving according to claim 1, wherein the driverless vehicle has a windshield and right and left windows and the at least one optical emitter of the driverless vehicle is disposed inside the driverless vehicle configured to be visible from outside via the windshield and right and left windows.

5. The system for remotely driving according to claim 4, wherein the at least one optical emitter comprises a front display system placed opposite the windshield, a right display system placed opposite the right window and a left display system placed opposite the left window.

6. The system for remotely driving according to claim 1, wherein the at least one movement sensor of the driverless vehicle comprises at least an inertial unit measuring the roll, pitch and yaw movements of the driverless vehicle at a driving location, and the at least one movement emitter comprises at least an actuator to replicate the roll, pitch and yaw movements in the seating station of the remote driving station.

7. The system for remotely driving according to claim 1, wherein the at least one movement sensor of the driverless vehicle comprises accelerometers measuring the vibrations at the level of the control devices at a driving location, and the at least one movement emitter comprises vibrators to replicate the vibrations in the corresponding piloting devices of the remote driving station.

8. The system for remotely driving according to claim 1, wherein the autonomous or assisted driving unit comprises a selection means implementing a selection between:
an autonomous or assisted piloting mode corresponding to piloting exclusively by the autonomous or assisted driving unit; or
a remote piloting mode corresponding to piloting by the remote driver;
and wherein the selection means is designed so as to implement:
a collection of information relating to one or several driving parameter(s);
a comparison of the driving parameter(s) with one or several associated safety threshold(s);
an activation of the autonomous or assisted piloting mode if one of the driving parameters exceeds the corresponding safety threshold.

9. The system for remotely driving according to claim 1, wherein the driving parameters comprise at least one communication parameter representative of the communication channel established between the telecommunication devices.

10. The system for remotely driving according to claim 9, wherein the communication parameter is selected amongst at least one of the following parameters:
a parameter representative of a signal quality;
a parameter representative of a transmission speed;
a parameter representative of a transmission latency;
a parameter representative of a bandwidth of the communication;
a parameter representative of a transmission rate;
a parameter representative of an authentication of the data; and
a parameter representative of a synchronization between the driver telepresence terminal and the vehicle telepresence terminal which communicate in the communication channel.

11. The system for remotely driving according to claim 1, wherein the driving parameters comprise at least one parameter selected amongst the following parameters:
a parameter representative of a trajectory or of a direction of the driverless vehicle;
a parameter representative of a speed or of an acceleration or of a deceleration of the driverless vehicle;
a parameter representative of a presence of an obstacle on the trajectory of the driverless vehicle; and
a parameter representative of a responsiveness level of the driver.

12. The system for remotely driving according to claims 8, 9, 10 and 11, wherein the selection means is designed so as to implement:
a collection of information relating to one or several communication parameter(s);
a collection of information relating to a parameter representative of a speed of the driverless vehicle;
a collection of information relating to a parameter representative of a presence of an obstacle on the trajectory of the driverless vehicle;
an assessment of a remote driving safety distance based on the parameter representative of a speed of the driverless vehicle and at least one communication parameter;
an assessment of a safety limit distance established on the basis of the parameter representative of a presence of an obstacle on the trajectory of the driverless vehicle, the parameter representative of a speed of the driverless vehicle and a maximum response time between the apparition of an obstacle on the trajectory of the driverless vehicle and the action of the driver on the driverless vehicle in a remote piloting mode; and
an activation of the autonomous or assisted piloting mode if the remote driving safety distance exceeds the safety limit distance.

13. The system for remotely driving according to claim 1, wherein the transmission tool comprises for the uplink stream processing means implementing a synchronization of the remote driving signals originating from the piloting devices and of the captured signals originating from the station sensors.

14. The system for remotely driving according to claim 13, wherein the processing means of the transmission tool for the uplink stream implement a synchronization and a multiplexing of the remote driving signals originating from the piloting devices and of the captured signals originating from the station sensors.

15. The system for remotely driving according to claim 14, wherein the processing means of the transmission tool for the uplink stream comprise a first processing block implementing an encoding and a compression of the captured signals originating from the station sensors, followed by a second processing block implementing a synchronization and a multiplexing of the remote driving signals originating from the piloting devices and of the captured signals encoded and compressed in the first processing block.

16. The system for remotely driving according to claim 1, wherein the processing means of the transmission tool for the downlink stream implementing a synchronization and a multiplexing of the captured signals originating from the vehicle sensors.

17. The system for remotely driving according to claim 16, wherein the processing means of the transmission tool for the downlink stream comprise a first processing block implementing an encoding and a compression of the captured signals originating from the vehicle sensors, followed by a second processing block implementing a synchronization and a multiplexing of the captured signals encoded and compressed in the first processing block.
